(19) United States
(12) Patent Application Publication
(10) Pub. No.: US 2007/0186629 A1
(43) Pub. Date: Aug. 16, 2007

(54) Functionalizable nanowire-based AFM probe

(76) Inventors: Ying-Lan Chang, Cupertino, CA (US); Maozi Liu, Fremont, CA (US); Sungsoo Yi, Sunnyvale, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/352,007

(22) Filed: Feb. 10, 2006

(51) Int. Cl. G01B 5/28

(52) U.S. Cl. 73/105

(57) ABSTRACT

The functionalizable nanowire-based AFM probe comprises a cantilever element, a semiconductor nanowire and a catalyst nanoparticle. The cantilever element comprises a crystalline growth surface at one end. The semiconductor nanowire extends substantially orthogonally from the growth surface and, hence from the cantilever element. The catalyst nanoparticle is located at the distal end of the nanowire, remote from the growth surface. The catalyst nanoparticle comprises a material having a greater tendency to bond with a functionalizing molecule moiety than the semiconductor material of the nanowire.

### RELATED APPLICATIONS

This application is also related to U.S. patent application Ser. No. ______ of Sungsoo Yi et al. entitled High Aspect Ratio AFM Probe and Method of Making (Agilent Docket No. 10060079-1) and to U.S. patent application Ser. No. ______ of Bo Curry et al. entitled Insertable Nanoscale FET Probe (Agilent Docket No. 10060080-1), both filed on the filing date of this application. The above applications are all assigned to the assignee of this application and the disclosures of the above applications are incorporated into this application by reference.

### BACKGROUND

During the last few years, the atomic force microscope (AFM) has increasingly been used as a powerful tool for performing biological studies. AFMs have been used to image such objects as molecules, cells, tissues and biomaterials. AFMs have additionally have been used to measure such forces as adhesion forces between individual proteins and interaction forces between polymeric systems and AFM tips functionalized with various molecules. AFM tips functionalized with proteins have been used to investigate the interaction of individual ligand-receptor complexes.

Additionally, a demand exists for single-cell manipulation to enable investigation of where and when molecules exhibit their various functions in controlling the activity of a cell. A functionalized AFM probe can be used to transfer a molecule of interest, such as a nucleic acid, a protein or other chemical compound into a living cell at a defined location and at a known time. The reaction of the cell in response to the molecule of interest can then be monitored in real-time. Such techniques can be applied not only for the investigation of cell activity but also in controlled differentiation or therapy of living cells.

A functionalized AFM probe whose probe tip is functionalized with a molecule of interest can be used to perform manipulations of the type just described. FIG. 1 shows an example of a conventional AFM probe 10 having a conventional AFM probe tip 12 that has been functionalized to make it useable for this purpose. Conventional AFM probe tip 12 is typically shaped like a pyramid with a polygonal or circular base. The distal end 14 of the probe tip, remote from the cantilever arm (not shown) from which the probe tip extends, is radiused. The radius of curvature is typically in the range from about 10 nm to about 60 nm.

Deposited on conventional AFM probe tip 12 is a thin metallic film 16. In a typical example, metallic film 16 is composed of a 5 nm-thick layer of chromium (Cr) in contact with the AFM probe tip and a 10 to 50 nm-thick layer of gold (Au) covering the layer of chromium. FIG. 1 does not show the layers individually. The coated AFM probe tip is then functionalized by immersing it in a solution of the functionalizing molecules, typically organic thiol molecules. At one end of each functionalizing molecule is a moiety that comprises a thiol (—SH) group. The thiol moieties of the functionalizing molecules self assemble to form a monolayer that covers the surface of metallic film 16. The functionalizing molecules have an appropriate functional group at their other ends. An example of the functionalizing molecules coating the surface of metallic film 16 deposited on AFM probe tip 12 is shown at 18. The functionalizing process just described covers substantially all the metallic film 16 deposited on conventional AFM probe tip 12 with functionalizing molecules.

Determinations of the interaction force between polymeric and biological systems and conventional AFM probe tips functionalized as just described have been demonstrated. However, the relatively large size of conventional AFM probe tip 12 results in AFM probe 10 having a relatively low spatial resolution. Moreover, since the area of the external surface 14 of conventional AFM probe tip 12 is relatively large and since substantially all the external 14 surface of conventional AFM probe tip 12 is covered with functionalizing molecules 18, multiple interactions occur when conventional AFM probe tip 12 is used to measure an interaction force between functionalizing molecules 18 and an object 20. In FIG. 1, object 20 is exemplified as a planar surface, but object 20 can have other shapes. Moreover, the pyramidal shape of functionalized AFM probe tip 12 causes the interactions to differ in magnitude due to the position-dependent distances between functionalizing molecules 18 and object 20. The interactive force on functionalized AFM probe tip 12 measured by the atomic force microscope (not shown) in which conventional AFM probe 10 is mounted is the collective effect of all the interactions between the functionalizing molecules and the object. This makes it difficult to determine the interactive force between a single functionalizing molecule and object. Thus, conventional functionalized AFM probe tips have a limited capability for use in studying intermolecular interactions at the single molecule level.

The low aspect ratio and relatively large cross-sectional area of conventional AFM probe tips similar to AFM probe tip 12 renders them unsuitable for use inside living cells. As used in this disclosure, the aspect ratio of an AFM probe tip is the length-to-width ratio of the probe tip. The length of a probe tip is the dimension of the probe tip in a length direction that extends between the base of the probe tip and the tip of the probe tip, and the width of a probe tip is the dimension of the probe tip in a width direction, orthogonal to the length direction.

Living cells are of the order of several micrometers thick: the length of a conventional AFM probe tip is insufficient to allow the probe tip to penetrate deep inside the cell. A conventional AFM probe long enough to penetrate as far into the cell as needed for some investigations would be so wide at its proximal end that it would cause the cell to rupture. Moreover, when a conventional AFM probe tip is used to deliver molecules to a point inside a cell, the width of the AFM probe tip in relation to the dimensions of the internal features of the cell makes the location to which molecules are delivered uncertain. Furthermore, a conventional AFM probe does not have a sharp end, which makes it difficult for the conventional AFM probe tip to penetrate through the cell membrane due to the small local pressure the probe tip can exert. Thus, conventional functionalized AFM probe tips have a limited capability for use in studying intracellular interactions.

Recently, long AFM probe tips with a high aspect ratio and a smaller cross-sectional area have been introduced, and penetration of such AFM probe tips into living cells has been successfully demonstrated. Such high aspect ratio AFM probe tip is fabricated by subjecting a conventional pyramidal AFM probe tip to focused ion beam (FIB) etching. However, functionalized versions of such high aspect ratio AFM probe tips suffer from the above-described problems of low spatial resolution, difficult-to-interpret data, relatively large lateral dimensions and functionalization over a wide area. Moreover, the FIB process used to make such probe tips causes damage to the probe tip material, which makes the electrical properties of the probe tips unpredictable.

### BRIEF DESCRIPTION OF THE DRAWINGS

FIG. 1 is a schematic side view showing the functionalized probe tip of a conventional AFM probe.

FIGS. 2A and 2B are respectively a schematic side view and a schematic bottom view showing part of a functionalizable AFM probe in accordance with a first embodiment of the invention.

FIGS. 3A and 3B are respectively a schematic side view and a schematic bottom view showing part of a functionalizable AFM probe in accordance with a second embodiment of the invention.

FIG. 4 is an enlarged schematic side view showing the distal portion of the probe tip of a functionalized embodiment of the AFM probe shown in FIGS. 2A and 2B.

FIGS. 5A-5H illustrate a method in accordance with an embodiment of the invention for fabricating embodiments of the functionalizable AFM probe shown in FIGS. 2A and 2B or 3A and 3B.

FIG. 6A illustrates an alternative way of performing the sacrificial material deposition process shown in FIGS. 5C and 5D.

FIG. 6B illustrates an alternative way of performing the catalyst metal deposition process shown in FIG. 5E.

FIG. 7 illustrates another alternative way of performing the catalyst metal deposition process shown in FIG. 5E.

FIGS. 8A and 8B schematically illustrate an exemplary embodiment of a method for functionalizing the functionalizable AFM probe shown in FIGS. 2A and 2B.

FIG. 8C is an enlarged schematic side view showing the distal portion of the probe tip of the functionalized AFM probe shown in FIG. 8B.

### DETAILED DESCRIPTION

In accordance with an embodiment of the invention, a functionalizable nanowire-based AFM probe comprises a cantilever element, a semiconductor nanowire and a catalyst nanoparticle. The cantilever element comprises a crystalline growth surface at one end. The semiconductor nanowire extends substantially orthogonally from the growth surface. The catalyst nanoparticle is located at the distal end of the nanowire, remote from the growth surface. The catalyst nanoparticle comprises a material having a greater tendency to bond with a functionalizing molecule moiety than the semiconductor material of the nanowire. The nanowire and catalyst nanoparticle constitute at least part of the probe tip of the functionalizable AFM probe.

The functionalizable AFM probe is functionalizable in the sense that it is structured to enable the catalyst nanoparticle at the distal end of the AFM probe tip to be selectively functionalized with desired functionalizing molecules by any suitable functionalizing process. A functionalizing molecule is any molecule that provides the AFM probe tip with a desired chemical or physical property and that is capable of bonding with the catalyst nanoparticle in preference to the nanowire. A functionalizing molecule typically comprises a bonding moiety linked directly or indirectly to a moiety that will be called a molecule of interest. Typical molecules of interest include antibodies, antigens, DNA, RNA, oligonucleotides, peptides, proteins, receptors, enzymes, ligands, polymers and small molecules such as biotins. In some cases, the molecule of interest can be a cell, a bacterium or a virus. When the AFM probe tip is functionalized by dipping it in a solution of functionalizing molecules, for example, the greater tendency of the catalyst nanoparticle to bond with a moiety of the functionalizing molecules ensures that the functionalizing molecules bond to the catalyst nanoparticle rather than the nanowire.

In accordance with another embodiment of the invention, a functionalized AFM probe comprises a cantilever element, a semiconductor nanowire, a catalyst nanoparticle and functionalizing molecules. The cantilever element comprises a crystalline growth surface at one end. The semiconductor nanowire extends substantially orthogonally from the growth surface. The catalyst nanoparticle is located at the distal end of the nanowire, remote from the growth surface and has an external surface. The functionalizing molecules are localized to the external surface of the nanoparticle.

In the above embodiments, the dimensions and aspect ratio of the nanowire depend on the intended application of the AFM probe. With current fabrication technology, the nanowire can have a diameter as small as about 5 nm and a length of the order of micrometers. As a result, the probe tip can have a small cross-sectional area and can quite easily have an aspect ratio of the order of 100. The diameter of the catalyst nanoparticle is similar to that of the nanowire. A probe tip having such an aspect ratio and a small cross-sectional area can penetrate a living cell without causing the cell to rupture. The orthogonal orientation of the nanowire with respect to the cantilever element allows the AFM probe to be mounted conventionally in the host atomic force microscope.

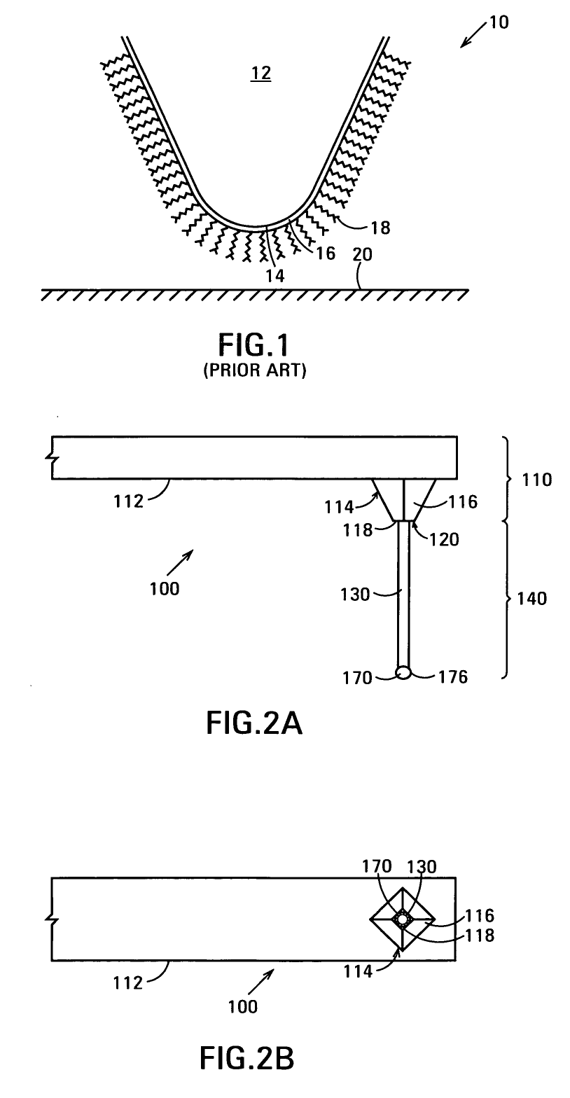

The radius of the nanoparticle is substantially smaller than that of the conventional AFM probe tip described above with reference to FIG. 1. Moreover, the greater tendency of the material of the catalyst nanoparticle to bond with a moiety of the functionalizing molecules localizes the functionalizing molecules to the external surface of the catalyst nanoparticle. This is in contrast to a conventional AFM probe tip in which the functionalizing molecules are located on the side surfaces in addition to the end of the probe tip. The small diameter of the catalyst nanoparticle constituting the distal end of the AFM probe tip in accordance with the invention provides a high spatial resolution, a high precision in the location at which functionalizing molecules are deposited by the AFM probe, and an ability to penetrate the membrane of a cell with minimal damage. Moreover, the simpler geometrical arrangement of the functionalizing molecules localized on the catalyst nanoparticle makes data generated by the AFM probe in accordance with the invention easier to interpret than data produced by a conventional AFM probe.

FIGS. 2A and 2B are respectively a schematic side view and a schematic bottom view showing part of an example of a functionalizable AFM probe 100 in accordance with a first embodiment of the invention. AFM probe 100 is composed of a cantilever element 110 having a crystalline growth surface 120 at one end, a semiconductor nanowire 130 extending substantially orthogonally from growth surface 120 and a catalyst nanoparticle 170 at the distal end of the nanowire, remote from growth surface 120. Catalyst nanoparticle 170 comprises a material having a greater tendency to bond with a functionalizing molecule moiety than the semiconductor material of nanowire 130. A growth surface that is closer to one end of the cantilever element than to the middle of the cantilever element will be regarded as being located at one end of the cantilever element. Nanowire 130 and catalyst nanoparticle 170 collectively constitute the functionalizable probe tip 140 of functionalizable AFM probe 100. Functionalizable probe tip 140 is capable of functionalization in a way that localizes the functionalizing molecules to the surface 176 of catalyst nanoparticle 170.

A crystalline growth surface such as crystalline growth surface 120 is a defined crystalline plane of the semiconductor material underlying the growth surface. In typical embodiments, the growth surface is the (111) crystalline plane of the underlying semiconductor material. A silicon nanowire grown on a silicon (111) crystalline plane will grow epitaxially, i.e., the crystallographic orientation of growth surface will be imposed on the nanowire, and the nanowire will grow in a direction substantially orthogonal to the growth surface. Typically, a nanowire will grow in a direction within ±10° of the orthogonal direction. Hence, a nanowire grown on a growth surface disposed parallel to the cantilever element will extend substantially orthogonally to the growth surface, and, hence, will additionally extend substantially orthogonally to the cantilever element.

In other embodiments, the growth surface is a (100) crystalline plane or a (110) crystalline plane of the underlying semiconductor material. It is typically more difficult to grow a silicon nanowire with good material quality on a silicon growth surface that is the (100) crystalline plane or the (110) crystalline plane than on a silicon growth surface that is the (111) crystalline plane. However, the (100) crystalline plane and/or the (110) crystalline plane can give better material quality than the (111) crystalline plane in nanowires grown from semiconductor materials other than silicon.

In functionalizable AFM probe 100, cantilever element 110 is composed of a cantilever arm 112 and a frusto-pyramidal probe tip base 114 located at one end of cantilever arm 112. As used in this disclosure, the term frusto-pyramidal encompasses frusto-conical, a cone being a pyramid having a base with an infinite number of sides. A probe tip base that is closer to one end of cantilever arm 112 than to the middle of cantilever arm 112 will be regarded as being at one end of cantilever arm 112. FIGS. 2A and 2B show only a portion of cantilever element 110 and cantilever arm 112 adjacent probe tip base 114 to enable probe tip base 114, nanowire 130 and catalyst nanoparticle 170 to be shown in more detail. Cantilever arm 112 is attached to the host AFM microscope (not shown) at or adjacent its other end (not shown).

Probe tip base 114 has crystalline side facets, an exemplary one of which is shown at 116, and, at its distal end, remote from cantilever arm 112, a crystalline end facet 118. In this first embodiment, end facet 118 provides growth surface 120, i.e., nanowire 130 extends from end facet 118. End facet 118 is substantially parallel to cantilever arm 112, i.e., end facet 118 is parallel to cantilever arm 112 typically within ±10°. End facet 118 is typically less than about 0.01 μm² in area.

In a typical embodiment, a monolithic, a single-crystal semiconductor AFM probe having a frusto-pyramidal single-crystal silicon probe tip is used as cantilever element 110. Such monolithic, single-crystal semiconductor AFM probes are sold by NanoWorld AG of Neuchâtel, Switzerland. In such an AFM probe, the cantilever arm and probe tip are respective portions of a single piece of single-crystal silicon. In embodiments in which cantilever element 110 is electrically conducting, as is typically the case, the single-crystal silicon is doped with a suitable dopant such as arsenic. In other embodiments, cantilever arm 112 and probe tip base 114 are separate components joined together. In such embodiments, the material of cantilever arm 112 need not be a semiconductor.

Nanowire 130 extends substantially orthogonally from growth surface 120 provided by crystalline end facet 118 at the distal end of probe tip base 114, i.e., nanowire 130 extends in a direction typically within ±10° of the direction orthogonal to end facet 118. The material of nanowire 130 is a single-crystal semiconductor material, such as a single-crystal group IV semiconductor, e.g., silicon (Si); a single-crystal group III-V semiconductor, e.g., gallium arsenide (GaAs); or a single-crystal group II-VI semiconductor, such as zinc oxide (ZnO). In embodiments in which nanowire 130 is electrically conducting, the single-crystal semiconductor material of the nanowire is doped with a suitable dopant.

As will be described in more detail below, nanowire 130 is grown from catalyst nanoparticle 170 deposited on growth surface 120. Throughout the growth process, catalyst nanoparticle 170 remains at the distal end of the nanowire, remote from cantilever element 110. Catalyst nanoparticle 170 is a somewhat oblate spheroid. The material of catalyst nanoparticle 170 is an alloy of the semiconductor material of nanowire 130 and a catalyst metal. The material of catalyst nanoparticle 170 has a greater tendency to bond with a functionalizing molecule moiety than the semiconductor material of nanowire 130.

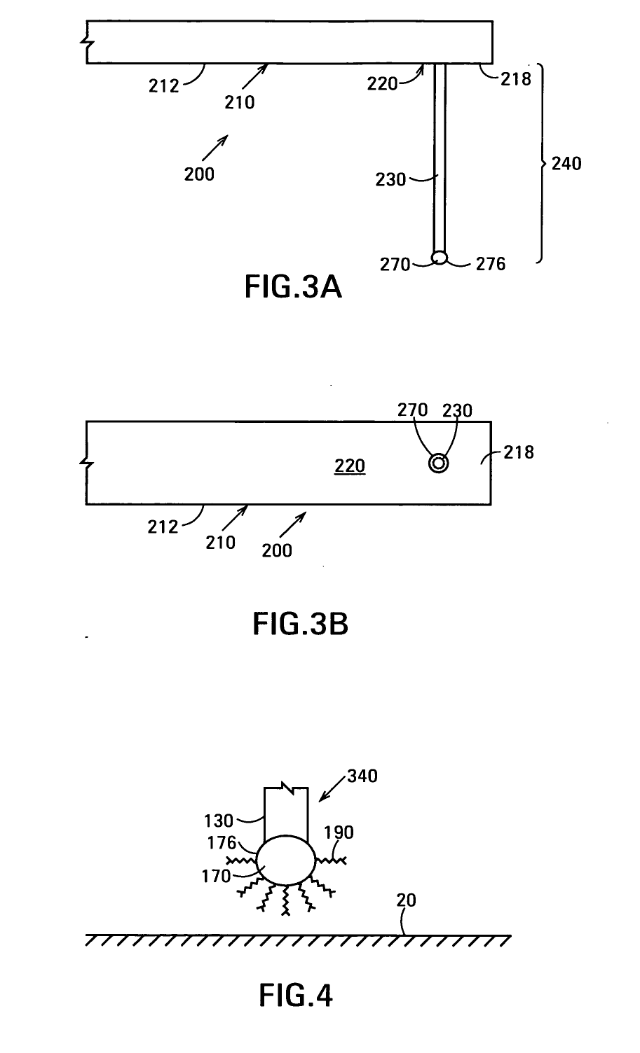

FIGS. 3A and 3B are respectively a schematic side view and a schematic bottom view showing part of a functionalizable AFM probe 200 in accordance with a second embodiment of the invention. AFM probe 200 is composed of a cantilever element 210 having a crystalline growth surface 220 at one end, a semiconductor nanowire 230 extending substantially orthogonally from growth surface 220 and a catalyst nanoparticle 270 at the distal end of the nanowire, remote from growth surface 220. Catalyst nanoparticle 270 comprises a material having a greater tendency to bond with a functionalizing molecule moiety than the semiconductor material of nanowire 230. Nanowire 230 and catalyst nanoparticle 270 collectively constitute the functionalizable probe tip 240 of functionalizable AFM probe 200. Functionalizable probe tip 240 is capable of functionalization in a way that localizes the functionalizing molecules to the external surface 276 of catalyst nanoparticle 270.

In functionalizable AFM probe 200, a cantilever arm 212 is used as cantilever element 210. FIGS. 3A and 3B show only a portion of cantilever element 210 and cantilever arm 212 adjacent nanowire 230 to enable nanowire 230 and catalyst nanoparticle 270 to be shown in more detail. Cantilever arm 212 is attached to the host AFM microscope (not shown) at or adjacent its other end (not shown).

In the example shown, cantilever arm 212 is an elongate piece of single-crystal semiconductor material in which one of the crystalline planes of the semiconductor material coincides with a major external surface 218 of the cantilever arm. In this second embodiment, the crystalline external surface 218 of cantilever arm 212 that coincides with one of the crystalline planes of the semiconductor material of cantilever arm 212 provides growth surface 220, i.e., nanowire 230 extends from external surface 218. In an embodiment, external surface 218 is substantially parallel to the longitudinal axis of cantilever arm 212, i.e., external surface 218 is parallel to the longitudinal axis of cantilever arm 212 typically within ±10°.

In a typical embodiment, a tipless, monolithic, single-crystal semiconductor AFM probe is used as cantilever element 210. Such tipless, monolithic, single-crystal semiconductor AFM probes are sold by NanoWorld AG of Neuchâtel, Switzerland. Such tipless AFM probe is a single piece of single-crystal silicon. In embodiments in which cantilever element is electrically conducting, as is typically the case, the single-crystal silicon is doped with a suitable dopant such as arsenic. In other embodiments (not shown), the material of the cantilever element is not a semiconductor. In such embodiments, the cantilever element has at one end a layer of crystalline semiconductor material on at least part of one of its major external surfaces. The exposed surface of the semiconductor material provides growth surface 220.

Nanowire 230 extends substantially orthogonally from growth surface 220 provided by the crystalline external surface 218 of cantilever arm 212, i.e., nanowire 230 extends in a direction typically within ±10° of the direction orthogonal to external surface 218. The material of nanowire 230 is a single-crystal semiconductor material, such as a single-crystal group IV semiconductor, e.g., silicon (Si); a single-crystal group III-V semiconductor, e.g., gallium arsenide (GaAs); or a single-crystal group II-VI semiconductor, such as zinc oxide (ZnO). In embodiments in which nanowire 230 is electrically conducting, the single-crystal semiconductor material is doped with a suitable dopant.

As will be described in more detail below, nanowire 230 is grown from catalyst nanoparticle 270 deposited on growth surface 220. Throughout the growth process, catalyst nanoparticle 270 remains at the distal end of the nanowire, remote from cantilever element 210. Catalyst nanoparticle 270 is a somewhat oblate spheroid. The material of catalyst nanoparticle 270 is an alloy of the semiconductor material of nanowire 230 and a catalyst metal. The material of catalyst nanoparticle 270 has a greater tendency to bond with a functionalizing molecule moiety than the semiconductor material of nanowire 230.

FIG. 4 is an enlarged view of the distal portion of the functionalized probe tip 340 of a functionalized embodiment of functionalizable AFM probe 100 described above with reference to FIGS. 2A and 2B. The following description also applies to the functionalized probe tip of a functionalized embodiment of functionalizable AFM 200 described above with reference to FIGS. 3A and 3B. Such functionalized embodiment of AFM probe 200 will not be separately described.

Functionalized probe tip 340 is composed of nanowire 130, catalyst nanoparticle 170 and functionalizing molecules localized on the surface of the catalyst nanoparticle. The surface 176 of catalyst nanoparticle 170 is covered by functionalizing molecules. An exemplary one of the functionalizing molecules is shown at 190. Reference numeral 190 will be used to refer to the functionalizing molecules collectively. Typically, the functionalizing molecules are organic thiols. Such molecules are polar molecules having at one end a thiol moiety comprising an —SH group. The —SH groups of the functionalizing molecules bond to the surface 176 of catalyst nanoparticle 170 to form a self-assembling monolayer that covers surface 176. The —SH group has a greater tendency to bond with surface 176 than with the semiconductor material of nanowire 130. As a result, functionalizing molecules 190 are localized on the surface 176 of catalyst nanoparticle 170.

A molecule of interest is located at the other end of each functionalizing molecule 190. A molecule of interest is any molecule that gives functionalized probe tip 340 a desired chemical or physical property. Typical molecules of interest include antibodies, antigens, DNA, RNA, oligonucleotides, peptides, proteins, receptors, enzymes, polymers, ligands and small molecules such as biotins. In some cases, the molecule of interest can be a cell, a bacterium or a virus. The molecule of interest can be directly modified by covalently bonding to a thiol moiety. Alternatively, the molecule of interest can be indirectly modified by bonding to a thiolated linker molecule via a non-covalent interaction, for example, an electrostatic interaction, hydrogen binding or a specific interaction such as the molecular recognition between antibody-antigen, streptavid-biotin, donor-receptor, etc. Techniques for thiolating typical molecules of interest to form the functionalizing molecules are known in the art and will therefore not be described here. Alternatively, pre-thiolated molecules of interest may be purchased for use as functionalizing molecules 190.

As noted above and as will be described in more detail below, the functionalized AFM probe may be used to measure an interaction force or another parameter resulting from an interaction of the molecules of interest with another object 20. Additionally or alternatively, the functionalized AFM probe may be used to deposit the molecules of interest at a defined location, for example, at a specific location inside a living cell.

Organic selenolates, which are analogous to respective organic thiols but have a selenium atom instead of a sulfur atom, are also capable of forming self-assembling monolayers and may be used as the functionalizing molecules instead of such organic thiols. Organic selenolates have a greater adsorptivity with respect to gold than corresponding organic thiols. Organic selenolates are described further by Huang et al., Selenolates as Alternatives to Thiolates for Self-Assembled Monolayers: a SERS Study, 14 LANGMUIR 4802-4808 (1998).

Functionalizable AFM probe 100 may be functionalized by its manufacturer to provide the functionalized AFM probe. In this case, the manufacturer of functionalized AFM probe 100 sells the functionalized AFM probe. In an alternative, functionalizable AFM probe 100 may be functionalized by its user to provide the functionalized AFM probe. In this case, the manufacturer of functionalizable AFM probe 100 sells functionalizable AFM probe 100. In another alternative, functionalizable AFM probe 100 may be functionalized by a third party to provide the functionalized AFM probe. In this case, the manufacturer of functionalizable AFM probe 100 sells functionalizable AFM probe 100 and the third party sells the functionalized AFM probe.

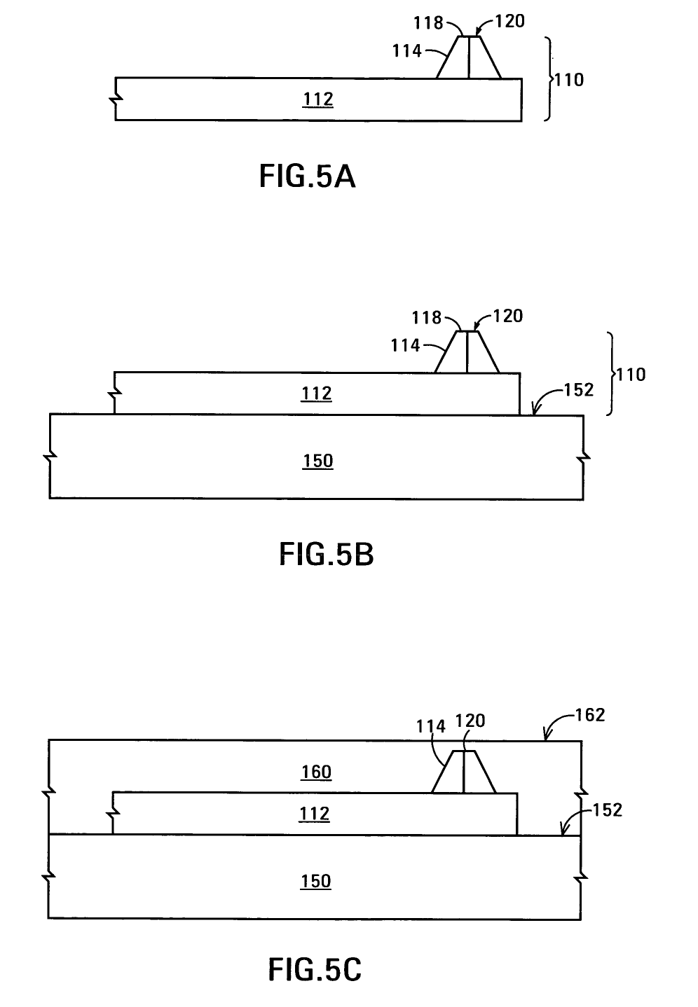

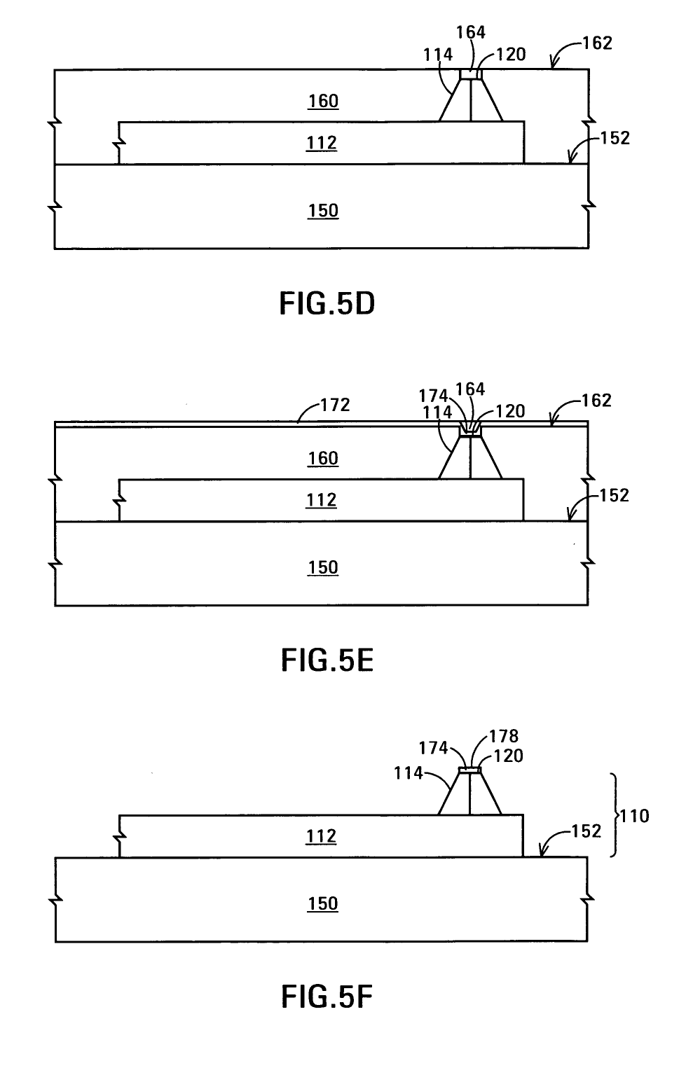

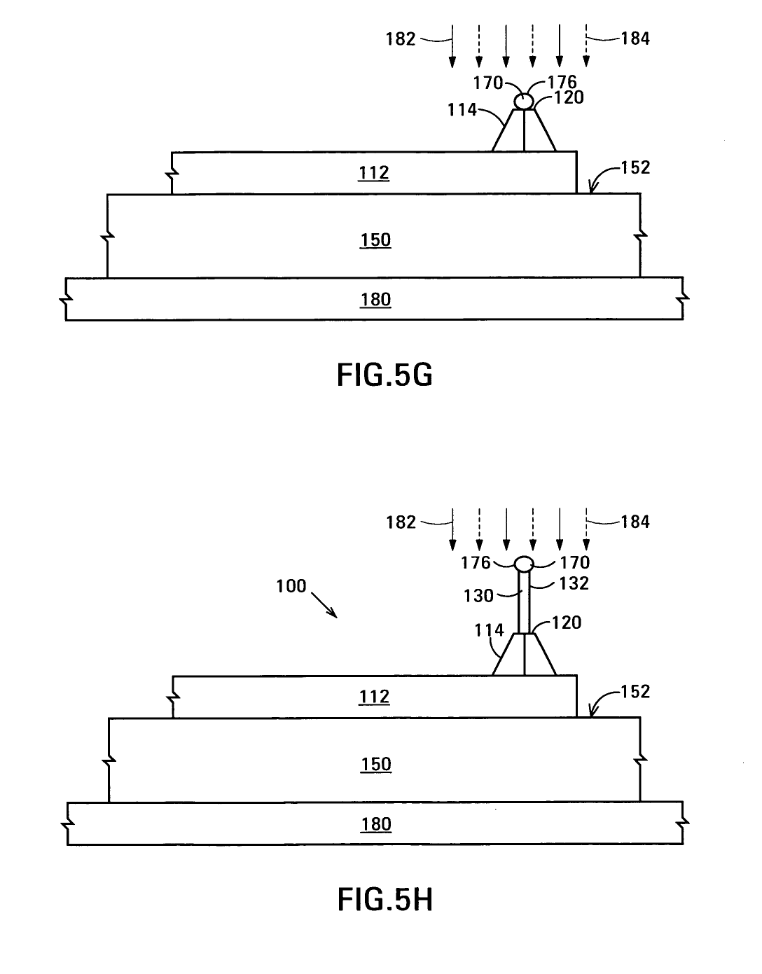

An example of a method in accordance with an embodiment of the invention for making functionalizable AFM probes in accordance with the invention will be described next with reference to FIGS. 5A-5H. The method will be described primarily with reference to an example in which it is used to make functionalizable AFM probe 100, but information relating to its use to make functionalizable AFM probe 200 will also be given where appropriate.

A cantilever element having a crystalline growth surface at one of its ends is provided. FIG. 5A shows an embodiment of cantilever element 110 composed of a cantilever arm 112 having a frusto-pyramidal probe tip base 114 at one end. Frusto-pyramidal probe tip base 114 has a crystalline end facet 118 at its distal end, remote from cantilever arm 112. Crystalline end facet 118 provides the crystalline growth surface 120 of cantilever element 110. FIG. 5A shows only a portion of cantilever arm 112 adjacent probe tip base 114 to enable probe tip base 114 to be shown in more detail. Alternatively, cantilever element 210 described above with reference to FIGS. 3A and 3B may be provided.

As noted above, a conventional monolithic single-crystal AFM probe with a frusto-pyramidal probe tip is typically used as cantilever element 110. Also as noted above, a conventional tipless monolithic single-crystal semiconductor AFM probe is typically used as cantilever element 210. Such conventional AFM probes can be commercially supplied mounted in the wafer of single-crystal silicon in which they are defined. Thus, cantilever elements including cantilever element 110 or cantilever element 210 can be commercially supplied mounted in the wafer of single-crystal silicon (not shown) in which they are defined. This wafer will be referred to as a probe wafer. The cantilever elements are joined to the probe wafer by narrow beams that extend from each cantilever element to the remainder of the probe wafer. Many functionalizable AFM probes similar to AFM probe 100 or AFM probe 200 are fabricated at a time by subjecting the probe wafer in which cantilever elements are defined to the processing described below with reference to FIGS. 5B-5H. Such wafer-scale fabrication makes the functionalizable AFM probes inexpensive to fabricate. Alternatively, the processing described herein with reference to FIGS. 5A-5H may be adapted to make small batches of functionalizable AFM probes similar to AFM probe 100 or AFM probe 200 from the cantilever elements supplied mounted in a portion of a full probe wafer, or to make individual instances of functionalizable AFM probe 100 or functionalizable AFM probe 200.

FIGS. 5A-5H illustrate, and the following description describes, the fabrication of functionalizable AFM probe 100 in accordance with the invention on a portion of the probe wafer (not shown) constituting one cantilever element 110. As AFM probe 100 is fabricated, AFM probes similar to AFM probe 100 are fabricated on the remaining cantilever elements in the probe wafer.

In the example shown, cantilever arm 112 and probe tip base 114 are respective portions of a single piece of single-crystal silicon. The end facet 118 of probe tip base 114 is substantially parallel to cantilever arm 112, as defined above, and is typically the (111) crystalline plane of the silicon of the probe tip base. A group IV or group III-V semiconductor nanowire grown on the (111) crystalline plane of silicon will grow epitaxially, i.e., the crystallographic orientation of the semiconductor material at the end facet of the probe tip base imposes a specific crystallographic orientation on the nanowire, and the nanowire will grow in a direction substantially orthogonal to the crystalline plane. Hence, nanowire 130 that later will be grown on the growth surface 120 of cantilever element 110 will extend substantially orthogonally from the growth surface, and, hence, will additional extend substantially orthogonally to cantilever arm 112. Probe tip base 114 may alternatively be a suitably-shaped piece of single-crystal silicon mounted on cantilever arm 112. In such an embodiment, the end facet 118 of probe tip base 114 that provides growth surface 120 is the (111) crystalline plane of the silicon of the probe tip base so that the growth direction of nanowire 130 is defined as described above. In other embodiments, end facet 118 is a (100) or a (110) crystalline plane, although, as noted above, it is more difficult to grow silicon nanowires with good material quality on such crystalline planes than on the (111) crystalline plane. In the fabrication of AFM probe 200, cantilever element 210 is composed of cantilever arm 212, which is a piece of single-crystal silicon. At least part of the external surface 218 of cantilever arm 212 provides crystalline growth surface 220.

In specific examples, cantilever arm 112 and probe tip base 114 are the cantilever arm and probe tip, respectively, of a monolithic single-crystal AFM probe having a frusto-pyramidal single-crystal silicon probe tip sold by NanoWorld AG of Neuchâtel, Switzerland, and cantilever arm 212 is a tipless monolithic single-crystal AFM probe sold by NanoWorld AG.

The probe wafer in which the cantilever elements including cantilever element 110 are supplied typically has apertures extending between its major surfaces. The apertures make the probe wafer incompatible with the vacuum chucks used in some of the processes described below. At least to remedy this incompatibility, the probe wafer is temporarily mounted on the major surface 152 of a handle wafer 150 with growth surface 120 facing away from major surface 152, as shown in FIG. 5B. Handle wafer 150 is a wafer of conventional thickness, i.e., about 0.5 mm. In the following description, processes described as being applied to the handle wafer are applied to the handle wafer and all elements currently supported by the handle wafer. Additionally, operations described as being applied to the probe wafer are applied to the probe wafer, the cantilever elements defined in the probe wafer and all layers currently supported by the probe wafer.

In an embodiment, handle wafer 150 is a wafer of single-crystal silicon and the probe wafer is temporarily attached to the handle wafer using clips (not shown). Alternative handle wafer materials include ceramics, sapphire and other suitable materials. In another embodiment, cantilever elements similar to cantilever element 110 are supplied temporarily mounted on a handle wafer.

The cantilever element is covered with sacrificial material leaving at least part of the growth surface exposed. In the example shown, a sacrificial layer 160 of sacrificial material is deposited with a nominal thickness greater than the distance from handle wafer surface 152 to growth surface 120 so that the sacrificial layer initially covers cantilever element 110, including growth surface 120, as shown in FIG. 5C. A portion of the sacrificial material constituting sacrificial layer 160 is then removed to form a window 164 that exposes at least part of growth surface 120, as shown in FIG. 5D.

In an embodiment, the sacrificial material constituting sacrificial layer 160 was photoresist. The photoresist was deposited on the probe wafer by spin coating to cover cantilever element 110, including cantilever arm 112 and probe tip base 114, as shown in FIG. 5C. The viscosity of the sacrificial material and the spin speed were set to obtain a nominal layer thickness sufficient to cover growth surface 120 with a layer having a nominal thickness of about 100 nm. Other sacrificial materials that are compatible with the subsequently-performed processing and that can be applied in a manner that produces a planar surface 162 are known in the art and may alternatively be used.

As a further alternative, a layer of a material that covers underlying elements conformally may be deposited with a thickness sufficient to cover growth surface 120 to provide sacrificial layer 160. An example of a conformally-covering material is silicon dioxide (SiO₂) deposited by chemical vapor deposition (CVD).

The portion of the sacrificial material constituting sacrificial layer 160 that is removed to form window 164 was defined by electron beam lithography. Other lithographic techniques such photolithography and nanoimprint lithography are known in the art and may alternatively be used. The size of window 164 determines the size of the catalyst metal (174 in FIG. 5E) deposited on growth surface 120 and, hence, the diameter of the subsequently-grown nanowire. In an embodiment, window 164 was circular and had a diameter in the range from about 5 nm to about 20 nm. In an embodiment in which photoresist used as sacrificial layer 160, the portion removed to form window 164 was removed by subjecting the probe wafer to the appropriate developer. Directional reactive ion etching or another etching technique can be used to remove any residual sacrificial material remaining on growth surface 120 after the growth surface has been exposed.

In an embodiment in which the material of sacrificial layer 160 was silicon dioxide, the portion removed to form window 164 was removed by subjecting the probe wafer to a wet etch process using dilute hydrofluoric acid (HF) as etchant. Alternatively, in such embodiment in which the material of sacrificial layer 160 was silicon dioxide, the portion removed to form window 164 was removed by subjecting the sacrificial material to chemical mechanical polishing (CMP) to expose growth surface 120. CMP should not be used to remove the portion of sacrificial layer 160 to form window 164 in the fabrication of functionalizable AFM probe 200.

The processing described above with reference to FIGS. 5C and 5D typically leaves growth surface 120 covered by a thin layer of native silicon dioxide that, if left in place, would hinder the epitaxial growth of nanowire 130 (FIG. 2A) on growth surface 120. Accordingly, such native oxide layer is removed by subjecting growth surface 120 to an etchant that dissolves silicon dioxide.

In an embodiment, the layer of native silicon dioxide was removed from growth surface 120 by subjecting the probe wafer to a wet etch process using dilute hydrofluoric acid (HF) as the etchant. In another embodiment, the layer of native silicon dioxide was removed by subjecting the probe wafer to a dry etch process using HF vapor as the etchant.

Catalyst metal suitable for catalyzing a vapor-liquid-solid nanostructure growth process is then deposited on the growth surface. FIG. 5E shows a layer 172 of catalyst metal deposited on the surface 162 of sacrificial layer 160 and on the portion of the growth surface 120 of cantilever element 110 exposed by window 164 defined in sacrificial layer 160. The portion of catalyst metal layer 172 deposited on the exposed portion of growth surface 120 is indicated by the reference numeral 174.

The material of catalyst metal layer 172 is a metal capable of catalytically decomposing a gaseous precursor to release a respective constituent element of the semiconductor material of nanowire 130 (FIG. 2A). Typical catalyst metals are gold (Au), nickel (Ni), palladium (Pd) and titanium (Ti).

In an embodiment, catalyst metal layer 172 is deposited using electron beam evaporation. Catalyst metal layer may alternatively be deposited by a conventional electroplating process or an electroless plating process.

In another embodiment, galvanic displacement is used to deposit catalyst metal selectively on growth surface 120. In an example in which the catalyst metal is gold, an electrical connection is made to probe tip base 114 via cantilever arm 112 and handle wafer 150, and the probe wafer is placed in a solution of gold potassium cyanide (AuK(CN)₂) or another suitable electrolyte. A suitable anode is also placed in the electrolyte and a current is passed through the electrolyte between the anode and the probe wafer. The silicon of growth surface 120 acts as a reducing agent and the catalyst metal is selectively deposited on the growth surface through a redox mechanism.

The sacrificial material is then removed. Removing the sacrificial material leaves the catalyst metal deposited on the growth surface. FIG. 5F shows cantilever element 110 and handle wafer 150 after sacrificial layer 160 (FIG. 5D) has been removed. Removing sacrificial layer 160 removes the portion of catalyst metal layer 172 located on the surface 162 of the sacrificial layer, but leaves catalyst metal 174 located on the exposed portion of growth surface 120.

In an embodiment, sacrificial layer 160 of photoresist is removed by a lift-off process in which the probe wafer is immersed in acetone ((CH₃)₂CO). Sacrificial layer 160 of silicon dioxide may be removed by subjecting the probe wafer to a wet etch process in which dilute hydrofluoric acid (HF) is used as etchant.

A semiconductor nanowire is then grown extending from the growth surface using the catalyst metal remaining on the growth surface as catalyst. FIGS. 5G and 5H show nanowire 130 being grown extending from growth surface 120 using catalyst metal 174 (FIG. 5F) remaining on the growth surface as catalyst in a vapor-liquid-solid growth process.

In an embodiment, handle wafer 150 is placed on the susceptor 180 of a chemical vapor deposition (CVD) reactor (not shown) and the susceptor and, hence, the handle wafer and the probe wafer, are heated to a deposition temperature near the eutectic point of an alloy between catalyst metal 174 and the semiconductor material from which nanowire 130 will be grown. In an embodiment in which catalyst metal 174 was gold and the semiconductor material from which nanowire 130 is grown was silicon, the susceptor was heated to a growth temperature of about 450° C.

A growth pressure is established inside the CVD reactor and a gaseous precursor mixture is passed over the probe wafer. In FIG. 5G, the gaseous precursor mixture is represented by solid arrows, an exemplary one of which is shown at 182. Reference numeral 182 will be used to refer to the gaseous precursor mixture. Gaseous precursor mixture 182 is composed of a substantially inert carrier gas and one or more precursors in a gaseous state. The precursors include a precursor for each constituent element of the semiconductor material of nanowire 130 and, optionally, a precursor for each dopant (typically only one dopant) for the semiconductor material of nanowire 130. In an embodiment in which the semiconductor material of nanowire 130 has a single constituent element, such as silicon, gaseous precursor mixture 182 is composed of the carrier gas, a precursor that comprises the single constituent element and, optionally, a precursor for the element with which the semiconductor material is doped. Exemplary precursors for silicon are silane (SiH₄) and disilane (Si₂H₆). An exemplary precursor for arsenic, a typical n-type dopant for silicon, is arsine (AsH₃). In an embodiment in which the bulk semiconductor material of nanowire 130 is a compound semiconductor, i.e., a semiconductor such as gallium arsenide (GaAs) having more than one constituent element, the gaseous precursor mixture is composed of the carrier gas, one or more precursors that collectively comprise the constituent elements of the compound semiconductor, and, optionally, a precursor for the element with the bulk semiconductor material is doped. Typically, such gaseous precursor mixture has a different precursor for each constituent element of the compound semiconductor material and the optional dopant. In an example in which the material of nanowire 130 was gallium arsenide, the precursors were trimethyl gallium (TMG) for gallium, arsine (AsH₃) for arsenic, and, optionally, silane (SiH₄) for silicon, a typical n-type dopant for gallium arsenide.

Further details of the growth of nanowire 130 will now be described with reference to an example in which the semiconductor material of nanowire 130 has a single constituent element, namely, silicon. The description below can readily be applied to the growth of a nanowire whose semiconductor material is a compound semiconductor. The precursor and adatoms of the dopant will not be mentioned in the following description.

Molecules of the precursor in gaseous precursor mixture 182 that contact catalyst metal 174 (FIG. 5F) are catalytically decomposed by the catalyst metal. Adatoms of the constituent element resulting from the decomposition of the precursor are deposited on the surface 178 of catalyst metal 174. The deposited adatoms mix with catalyst metal 174 to form an alloy, which has a lower melting point than the original catalyst metal. The alloy melts to form a catalyst nanoparticle 170 shown in FIG. 5G.

Catalyst nanoparticle 170 is capable of catalytically decomposing the precursors in precursor mixture 182. Consequently, additional adatoms of the constituent element(s) are deposited on the surface 176 of catalyst nanoparticle 170 and increase the fraction of the constituent element in the alloy until the alloy becomes saturated with the constituent element. Then, further adatoms of the constituent element cause a corresponding number of atoms of the constituent element to be released from catalyst nanoparticle 170 at its surface adjacent growth surface 120. The released atoms grow epitaxially on the growth surface to form a solid nanowire 130 that extends orthogonally from the growth surface.

Further deposition of adatoms of the constituent element on molten catalyst nanoparticle 170 cause the release of additional atoms of the constituent element from the molten catalyst nanoparticle and an increase in the length of nanowire 130, as shown in FIG. 5H. The process of passing gaseous precursor mixture 182 over the probe wafer is continued until nanowire 130 reaches its design length. Molten catalyst nanoparticle 170 remains at the distal end of nanowire 130, remote from growth surface 120, throughout the nanowire growth process.

Nanowire 130 has a lateral surface 132 that, during the growth of the nanowire, is also exposed to gaseous precursor mixture 182. Some of the molecules of the precursor in gaseous precursor mixture 182 contact lateral surface 132 and decompose non-catalytically to deposit respective adatoms of the constituent element on lateral surface 132. Such adatoms accumulate on lateral surface 132. The rate of lengthways growth of nanowire 130 is substantially constant, so the time that an annular segment of lateral surface 132 is exposed to gaseous precursor mixture 182 is inversely proportional to the distance of the annular segment from growth surface 120. Consequently, adatoms accumulated on lateral surface 132 cause the cross-sectional area of nanowire 130 to increase towards growth surface 120. As a result, nanowire 130 has a tapered shape, rather than the non-tapered shape shown. If the taper is not severe, such a tapered shape is acceptable, and may be desirable, in some applications.

In applications in which the non-tapered shape of nanowire 130 shown in FIGS. 2A and 3A is desirable, i.e., in which nanowire 130 has a uniform cross-sectional area along its length, a gaseous etchant is passed over the growth wafer in addition to precursor mixture 182. The gaseous etchant is represented in FIGS. 5G and 5H by broken arrows 184. Reference numeral 184 will be used to refer to the gaseous etchant. Gaseous etchant 184 removes the adatoms of the constituent element from lateral surface 132 by forming a volatile compound with the adatoms of the constituent element deposited on lateral surface 132. The volatile compound is volatile at the growth temperature and growth pressure established inside the CVD reactor. As the carrier gas that forms part of precursor mixture 182 passes over the probe wafer, it carries the molecules of the volatile compound away from lateral surface 132 into the exhaust system of the CVD reactor. The etch rate of the adatoms deposited on lateral surface 132 is several orders of magnitude greater than that of the crystalline material of the lateral surface itself. As a result, the gaseous etchant removes the adatoms but has a negligible etching effect on lateral surface 132.

In an embodiment, gaseous etchant 184 was a halogenated hydrocarbon, such as halogenated methane. In one example, the halogenated methane was carbon tetrabromide (CBr₄). In another example, the halogenated methane was carbon tetrachloride (CCl₄). Not all the hydrogen atoms of the halogenated hydrocarbon need be substituted. Moreover, ones of the hydrogen atoms may be replaced by different halogens. In another embodiment, gaseous etchant 184 was a hydrogen halide (HX), where X=fluorine (F), chlorine (Cl), bromine (Br) or iodine (I).

In another embodiment, gaseous etchant 184 is provided by using a halogen-containing precursor as the precursor for at least one of the constituent elements. The halogen-containing precursor forms part of gaseous precursor mixture 182 passed over the probe wafer. The halogen-containing precursor is catalytically decomposed at the surface 176 of nanoparticle 170. Adatoms of the constituent element are deposited on surface 176 and the halogen is released into the gaseous precursor mixture. The carrier gas carries the halogen released from the halogen-containing precursor to the lateral surface 132 of nanowire 130 as gaseous etchant 184. Additional halogen may be released by non-catalytic decomposition of the halogen-containing precursor at the lateral surface. At lateral surface 132, the halogen combines with adatoms newly-deposited on the lateral surface to form a volatile compound and the carrier gas carries the volatile compound away from the lateral surface.

The probe wafer in which the functionalizable AFM probes including AFM probe 100 have been fabricated is then detached from handle wafer 150. In an embodiment, the probe wafer including AFM probe 100 is detached from handle wafer 150 by removing the clips (not shown) holding the wafers together.

In the above description, the probe wafer is detached from handle wafer 150 after nanowire 130 has been grown. Alternatively, the probe wafer can be detached from the handle wafer after sacrificial layer 160 has been removed but before nanowire 130 is grown. In this case, the probe wafer is placed directly on the susceptor 180 (FIG. 5G) of the CVD growth chamber.

In embodiments of the above method in which the probe wafer lacks apertures extending between its major surfaces, the handle wafer referred to above is unnecessary.

In embodiments of the above method in which the cantilever elements do not constitute part of a probe wafer, such cantilever elements may be mounted on the handle wafer (FIG. 5B) using double-sided adhesive tape. In an example, the double-sided adhesive tape was based on a polyimide film. After the sacrificial layer has been removed, leaving the catalyst metal on the growth surface, as described above with reference to FIG. 5F, the cantilever elements are removed from the handle wafer by carefully pulling them off the adhesive tape. The cantilever elements are then placed in appropriately-shaped recesses defined in the susceptor of the CVD growth chamber for the nanowire growth process described above with reference to FIGS. 5G and 5H. Alternatively, the cantilever elements may be mounted on the surface of an uncontoured susceptor using small clips.

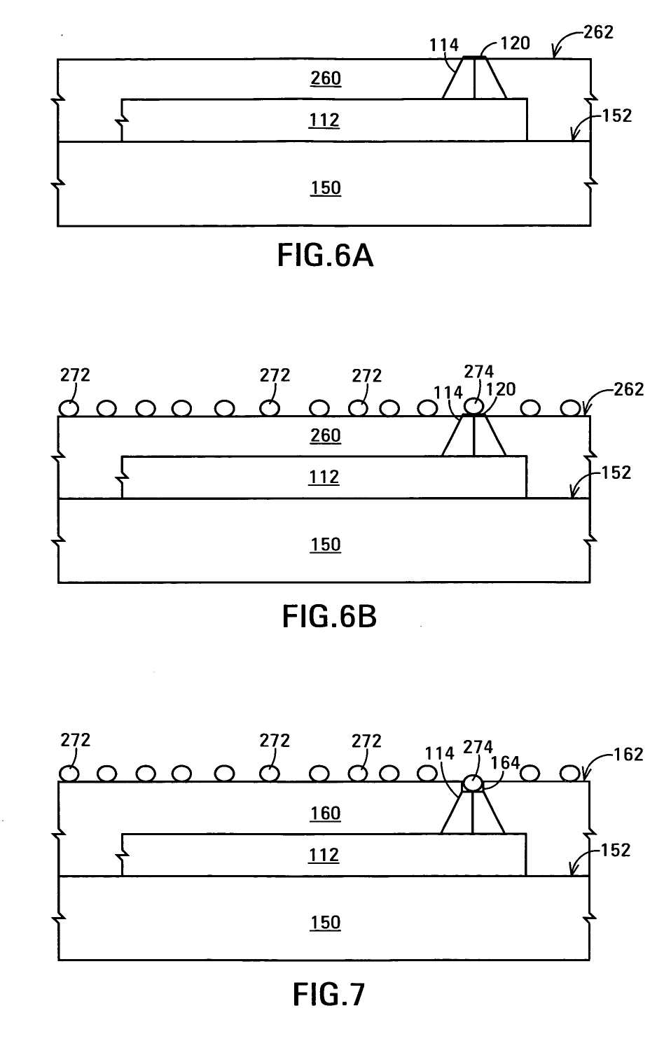

FIGS. 6A and 6B illustrate part of a method in accordance with another embodiment of the invention that may be used to make functionalized AFM probes similar to AFM probe 100. This method is a variation on the method described above with reference to FIGS. 5A-5H. The processes described above with reference to FIGS. 5A and 5B are performed. Then, instead of performing the processes described above with reference to FIGS. 5C and 5D to cover the cantilever element with sacrificial material leaving at least part of the growth surface exposed, the process described next with reference to FIG. 6A is performed. Moreover, instead of performing the process described above with reference to FIG. 5E to deposit catalyst metal on the growth surface, the process described next with reference to FIG. 6D is performed. The processes described above with reference to FIGS. 5F-5H are then performed to complete the fabrication of the functionalizable AFM probes.

FIG. 6A illustrates an alternative way of covering the cantilever element with sacrificial material leaving at least part of the growth surface exposed. FIG. 6A shows a sacrificial layer 260 of sacrificial material covering cantilever element 110 leaving growth surface 120 exposed. The thickness of sacrificial layer 260 is nominally slightly less than the distance from handle wafer surface 152 to growth surface 120 so that growth surface 120 projects from the surface 262 of sacrificial layer 260. Such a thickness of the sacrificial layer leaves growth surface 120 exposed. Directional reactive ion etching or another etching technique can be used to remove any sacrificial material from growth surface 120.

In an embodiment, the sacrificial material of sacrificial layer 260 was polymethylmethacrylate (PMMA). The PMMA sacrificial material was deposited by spin coating to cover handle wafer 150 and cantilever element 110, including cantilever arm 112 and probe tip base 114. The viscosity of the sacrificial material and the spin speed were set to obtain a nominal layer thickness about 100 nm less than the distance from handle wafer surface 152 to growth surface 120 so that the deposition process leaves growth surface 120 exposed. Sacrificial layer 260 of PMMA is later removed in the process described above with reference to FIG. 5F by a lift-off process in which the probe wafer is immersed in acetone ((CH₃)₂CO).

Photoresist deposited by spin coating may be used instead of PMMA as the sacrificial material of sacrificial layer 260. Other materials that are compatible with the subsequently-performed processing and that can be applied in a manner that produces a planar surface 262 are known in the art and may alternatively be used as the sacrificial material of sacrificial layer 260.

FIG. 6B illustrates an alternative way of depositing catalyst metal suitable for catalyzing a vapor-liquid-solid nanostructure growth process is deposited on the exposed growth surface. FIG. 6B shows nanoparticles of catalyst metal deposited on the surface 262 of sacrificial layer 260 and on growth surface 120 at the distal end of probe tip base 114, remote from cantilever arm 112. The fraction of the area of the surface 262 of sacrificial layer 260 occupied by growth surface 120 is very small. The nanoparticles of catalyst metal are applied at such an area density that, on average, more than zero but no more than one nanoparticle 274 is located on growth surface 120. Examples of the nanoparticles of catalyst metal located on the surface 262 of sacrificial layer 260 are shown at 272.

The catalyst metal constituting nanoparticles 272 and 274 is one capable of catalytically decomposing a gaseous precursor to release a respective constituent element of the semiconductor material of which nanowire 130 (FIG. 2A) will be grown. Typical catalyst nanoparticles are nanoparticles of gold (Au), nickel (Ni), palladium (Pd) or titanium (Ti).

The size of nanoparticle 274 determines the diameter of nanowire 130 (FIG. 2A). In an embodiment, the catalyst nanoparticles had an average diameter in the range from about 5 nm to about 20 nm.

In an embodiment, a solution containing colloidal nanoparticles of catalyst metal is spun onto the surface 262 of sacrificial layer 260. Handle wafer 150 is then gently heated to evaporate the liquid component of the colloidal solution. This leaves nanoparticle 274 located on growth surface 120 and nanoparticles 272 distributed over the surface 262 of sacrificial layer 260. In another embodiment, an aqueous solution of colloidal nanoparticles of catalyst metal is mixed with methanol (CH₃OH) and the resulting mixture is dropped onto the surface 262 of sacrificial layer 260. The mixture rapidly spreads over surface 262 and growth surface 120. The handle wafer is then gently heated to evaporate the liquid component of the dilute colloidal solution. This leaves nanoparticle 274 located on growth surface 120 and nanoparticles 272 distributed over surface 262 of sacrificial layer 260.

The processes described above with reference to FIGS. 5F-5H are then performed. Removing sacrificial layer 262 in the process described above with reference to FIG. 5F removes all of the nanoparticles 272 of catalyst metal located on the surface 262 of the sacrificial layer, but leaves nanoparticle 274 of catalyst metal located on growth surface 120. Sacrificial layer 260 of PMMA is removed by a lift-off process in which the probe wafer is immersed in acetone ((CH₃)₂CO).

FIG. 7 illustrates part of a method in accordance with yet another embodiment of the invention that may be used to make functionalized AFM probes similar to AFM probe 100 or to AFM probe 200. This method is a variation on the method described above with reference to FIGS. 5A-5H. The processes described above with reference to FIGS. 5A-5D are performed. Then, instead of performing the process described above with reference to FIG. 5E, the process described next with reference to FIG. 7 is performed. The processes described above with reference to FIGS. 5F-5H are then performed to complete the fabrication of the functionalizable AFM probes.

FIG. 7 illustrates an alternative way of depositing catalyst metal suitable for catalyzing a vapor-liquid-solid growth process on the growth surface. FIG. 7 shows nanoparticles of catalyst metal deposited on the surface 162 of sacrificial layer 160 and on growth surface 120 at the distal end of probe tip base 114, remote from cantilever arm 112. Growth surface 120 is exposed by removing a region of sacrificial layer 160 to form a window 164, as described above with reference to FIG. 5D. The area of window 164 represents a very small fraction of the area of the surface 162 of sacrificial layer 160. The nanoparticles of catalyst metal are applied at such an area density that, on average, more than zero but no more than one nanoparticle 274 is located in the window 164 that exposes growth surface 120. Examples of the nanoparticles of catalyst metal located on the surface 162 of sacrificial layer 160 are shown at 272. The properties of nanoparticles 272 and 274 and methods for depositing the nanoparticles are described above with reference to FIG. 6B.

The processes described above with reference to FIGS. 5F-5H are then performed. Removing sacrificial layer 162 in the process described above with reference to FIG. 5F removes all of the nanoparticles 272 of catalyst metal located on the surface 162 of the sacrificial layer, but leaves nanoparticle 274 of catalyst metal located on growth surface 120.

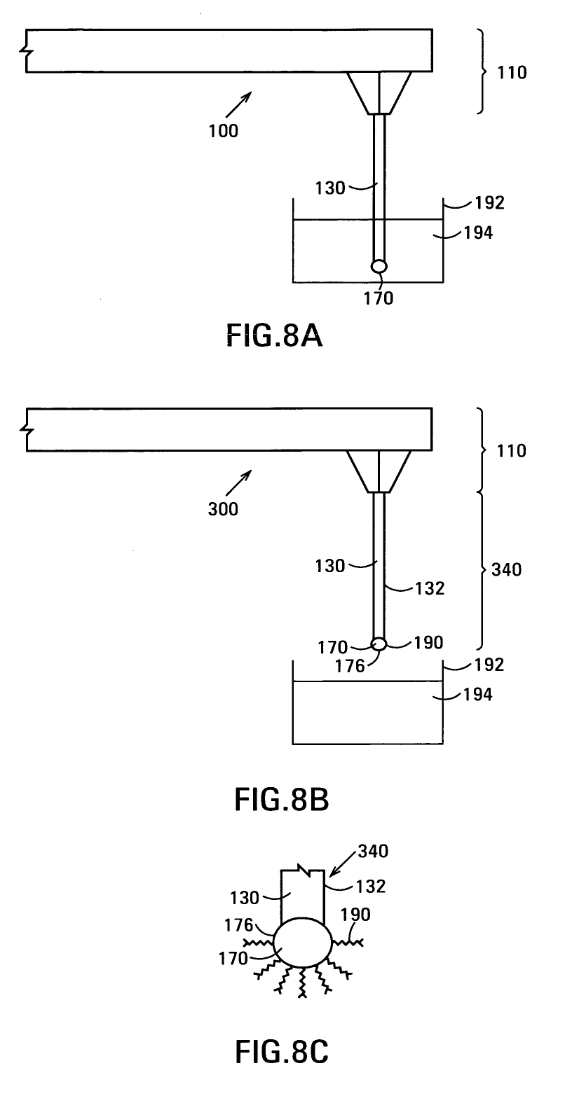

FIGS. 8A and 8B schematically illustrate an exemplary embodiment of a method for functionalizing functionalizable AFM probe 100 described above with reference to FIGS. 2A and 2B. The method may also be used to functionalize functionalizable AFM probe 200 described above with reference to FIGS. 3A and 3B. The method may be performed on functionalizable AFM probes that form all or part of a probe wafer, as described above, or may be performed on individual AFM probes. The method may be performed by the manufacturer of the functionalizable AFM probes, by the user of the functionalized AFM probes or by a third party. Any of these entities may perform the method on the wafer scale, the partial wafer scale or on the individual scale. The method will be described with reference to an example in which functionalizable AFM probe 100 is functionalized to form a functionalized AFM probe 300. The method may additionally be used to functionalize functionalizable AFM probe 200 to form a respective functionalized AFM probe.

FIG. 8A shows a container 192 containing a solution 194 of functionalizing molecules. In an example in which the functionalizing molecules are molecules of an alkanethiol (e.g., C₁₀H₂₁SH), solution 194 is a 0.1 mM solution of the alkanethiol in ethanol (C₂H₅OH). Alternatively, in embodiments in which a functionalizable AFM probe is functionalized individually, a drop of solution 194 is placed on a surface. Functionalizable AFM probe 100 is positioned relative to solution 194 such that catalyst nanoparticle 170 is immersed in solution 194. Positioning functionalizable AFM probe 100 relative to solution 194 typically also results of part of nanowire 130 being immersed in the solution, as shown in FIG. 8A, since the positioning need only be performed with the precision required to ensure that catalyst nanoparticle 170 is immersed in the solution.

The thiol moieties of the functionalizing molecules in solution 194 that contact catalyst nanoparticle 170 form a self-assembling monolayer that coats the external surface of the nanoparticle. Corresponding activity with respect to the functionalizing molecules that contact nanowire 130 occurs minimally, if at all.

The resulting functionalized AFM probe 300 is withdrawn from solution 194, as shown in FIG. 8B. The functionalizing molecules coating catalyst nanoparticle 170 are not shown in FIG. 8B, but are shown at 190 in the enlarged view of FIG. 8C, described below. Functionalized AFM probe 300 can then be washed using an organic solvent, such as pure ethanol (C₂H₅OH) or acetonitrile (CH₃CN). The washing process removes any of the functionalizing molecules physically adsorbed on the surface of nanowire 130 but removes few of the functionalizing molecules coating catalyst nanoparticle 170. Functionalized AFM probe 300 is then left to dry. Alternatively, functionalized AFM probe 300 may be blown dry using a stream of dry nitrogen (N₂) or another suitable gas.

FIG. 8C is an enlarged view showing the distal portion of the functionalized probe tip 340 of functionalized AFM probe 300 (FIG. 8B) after functionalized AFM probe 300 has been withdrawn from solution 194, washed and dried. Functionalizing molecules 190 remain distributed over the surface 176 of catalyst nanoparticle 170, but the washing process leaves few, if any, functionalizing molecules on the external surface 132 of nanowire 130. As a result, the functionalizing molecules 190 coating functionalized probe tip 340 are localized at the surface of catalyst nanoparticle 170.

Functionalized AFM probe 300 or a functionalized embodiment of AFM probe 200 is used by mounting it as the AFM probe of a host atomic force microscope (not shown) and using the atomic force microscope to perform measurements and manipulations that need a functionalized probe tip.

In an example of the use of functionalized AFM probe 300, the atomic force microscope is operated to place functionalized probe tip 340 adjacent a test subject whose activity is to be measured by measuring an interaction force between the test subject and the functionalizing molecules 190 coating functionalized probe tip 340. A stimulus is provided to the test subject and the atomic force microscope is used to measure the interaction force applied to the functionalized AFM probe by interaction between the functionalizing molecules coating functionalized probe tip 340 and the test subject. Alternatively, the AFM may be used to measure another parameter detected by functionalized AFM probe 300.

In an example of the use of functionalized AFM probe 300 to deliver its functionalizing molecules to a location of interest inside a living cell (not shown), the host AFM is operated to move functionalized AFM probe in the x- and y-directions to align functionalized probe tip 340 with the location of interest. The AFM is then further operated to move functionalized AFM probe 300 in the z-direction to bring functionalized probe tip 340 to the location of interest inside the cell. This causes functionalized probe tip 340 to penetrate the membrane of the cell. The small diameter and high aspect ratio of functionalized probe tip 340 allows functionalized probe tip 340 to penetrate the membrane without causing the membrane to rupture. Once functionalized probe tip 340 is at the location of interest inside the cell, a small voltage is applied to functionalized AFM probe 300. The voltage breaks the bonds between functionalizing molecules 190 and catalyst nanoparticle 170 and releases the functionalizing molecules into the cell at the location of interest.

The reaction of the cell to the functionalizing molecules released at the location of interest is then monitored. The monitoring may involve the AFM measuring the force applied by the cell to probe tip 340, now defunctionalized, as a result of the reaction. In another example, monitoring involves the AFM detecting a change in a mechanical vibration property, such as amplitude or frequency, of the cell. Other monitoring techniques may be used instead or in addition.

This disclosure describes the invention in detail using illustrative embodiments. However, the invention defined by the appended claims is not limited to the precise embodiments described.

We claim:

1. An atomic force microscope (AFM) probe, comprising
a cantilever element comprising a crystalline growth surface at one end thereof;
a nanowire extending substantially orthogonally from the growth surface, the nanowire comprising semiconductor material; and
a catalyst nanoparticle at a distal end of the nanowire, remote from the growth surface, the catalyst nanoparticle comprising a material having a greater tendency to bond with a functionalizing molecule moiety than the semiconductor material.

2. The AFM probe of claim 1, in which the cantilever element comprises:
a cantilever arm; and
a frusto-pyramidal probe tip base at an end of the cantilever arm, the probe tip base comprising a crystalline end facet at an end thereof remote from the cantilever arm, the end facet providing the crystalline growth surface.

3. The AFM probe of claim 2, in which the cantilever element comprises a monolithic single-crystal semiconductor AFM probe.

4. The AFM probe of claim 1, in which:
the cantilever element comprises a cantilever arm, the cantilever arm comprising single-crystal semiconductor material; and
at least part of the semiconductor material provides the crystalline growth surface.

5. The AFM probe of claim 1, in which the semiconductor material of the nanowire is single-crystal semiconductor material.

6. The AFM probe of claim 1, in which the semiconductor material of the nanowire is doped single-crystal semiconductor material.

7. The AFM probe of claim 1, in which the semiconductor material of the nanowire is epitaxial with respect to the growth surface.

8. The AFM probe of claim 1, additionally comprising functionalizing molecules bonded the catalyst nanoparticle.

9. The AFM probe of claim 8, in which the cantilever element comprises:
a cantilever arm; and
a frusto-pyramidal probe tip base at an end of the cantilever arm, the probe tip base comprising a crystalline end facet at an end thereof remote from the cantilever arm, the end facet providing the crystalline growth surface.

10. The AFM probe of claim 8, in which:
the cantilever element comprises a cantilever arm, the cantilever arm comprising single-crystal semiconductor material; and
at least part of the semiconductor material provides the crystalline growth surface.

11. A method of making a functionalizable atomic force microscope (AFM) probe, the method comprising:
providing a cantilever element comprising a crystalline growth surface at one end thereof;
covering the cantilever element with sacrificial material, leaving at least part of the growth surface exposed;
depositing catalyst metal on the exposed growth surface;
removing the sacrificial material, the removing leaving the catalyst metal on the growth surface; and
growing a nanowire extending from the growth surface using the catalyst metal left on the growth surface, the nanowire comprising a semiconductor material, the catalyst metal forming a catalyst nanoparticle at a distal end of the nanowire, the catalyst metal having a greater tendency to bond with a functionalizing molecule moiety than the semiconductor material of the nanowire.

12. The method of claim 11, in which covering the cantilever element comprises applying the sacrificial material using a spin-on process.

13. The method of claim 11, in which the removing is performed using a lift-off process.

14. The method of claim 11, in which the growing comprises passing a gaseous precursor mixture over the cantilever element, the gaseous precursor mixture comprising a precursor for a constituent element of the semiconductor material.

15. The method of claim 14, in which the growing additionally comprises passing a gaseous etchant over the cantilever element to grow the nanowire with a substantially uniform cross-sectional area along its length.

16. The method of claim 11, in which:
the cantilever element comprises single-crystal semiconductor material;
the growth surface is a (111) crystalline plane of the semiconductor material; and
the growing comprises epitaxially growing the nanowire on the growth surface.

17. The method of claim 11, in which:
the cantilever element comprises:
a cantilever arm, and
a frusto-pyramidal probe tip base at an end of the cantilever arm, the probe tip base comprising a crystalline end facet at an end thereof remote from the cantilever arm, the end facet providing the crystalline growth surface; and
the covering comprises covering the cantilever element with the sacrificial material with a thickness that leaves the end facet exposed.

18. The method of claim 11, in which the covering comprises:
covering the cantilever element with the sacrificial material with a thickness that covers the growth surface, and
removing a portion of the sacrificial material to expose the growth surface.

19. The method of claim 11, additionally comprising coating the catalyst nanoparticle with the functionalizing molecules.

20. The method of claim 19, additionally comprising releasing the functionalizing molecules from the catalyst nanoparticle.

21. A functionalized atomic force microscope (AFM) probe, comprising
a cantilever element comprising a crystalline growth surface at one end thereof;
a semiconductor nanowire extending substantially orthogonally from the growth surface;
a catalyst nanoparticle at a distal end of the nanowire, remote from the growth surface, the catalyst nanoparticle having an external surface; and
functionalizing molecules localized to the external surface of the catalyst nanoparticle.

22. The AFM probe of claim 21, in which the cantilever element comprises:
a cantilever arm; and
a frusto-pyramidal probe tip base at an end of the cantilever arm, the probe tip base comprising a crystalline end facet at an end thereof remote from the cantilever arm, the end facet providing the crystalline growth surface.

23. The AFM probe of claim 21, in which:
the cantilever element comprises a cantilever arm, the cantilever arm comprising single-crystal semiconductor material; and
at least part of the semiconductor material provides the crystalline growth surface.
